(19) United States
(12) Patent Application Publication
(10) Pub. No.: US 2017/0237805 A1
(43) Pub. Date: Aug. 17, 2017

(54) WORKER REUSE DEADLINE

(71) Applicant: DNANEXUS, INC., Mountain View, CA (US)

(72) Inventor: Evan M. WORLEY, Mountain View, CA (US)

(21) Appl. No.: 15/401,919

(22) Filed: Jan. 9, 2017

Related U.S. Application Data
(60) Provisional application No. 62/294,880, filed on Feb. 12, 2016.

(51) Int. Cl. H04L 29/08; H04L 12/26

(52) U.S. Cl. CPC H04L 67/10; H04L 67/325; H04L 43/08; H04L 67/42

(57) ABSTRACT

A computer implemented method for managing job scheduling is provided. In one example, the method includes receiving a request to process a job for a first compute instance, the job having a predetermined wait time before requesting a second compute instance, and determining the status of a pool of existing instances potentially available to service the job. If the probability that a computing instance of the pool will become available before the predetermined wait time is less than a predetermined probability, the method schedules the job to a new instance of the pool of existing instances. If the probability that a computing instance will become available before the predetermined wait time is greater than the predetermined probability the method maintains the job with the first instance. In some examples, the compute instances relate to genomic sequence data processing and analysis.

### CROSS-REFERENCE TO RELATED APPLICATIONS

This application claims priority to U.S. Provisional Patent Application No. 62/294,880 filed Feb. 12, 2016, the disclosure of which is hereby incorporated by reference in its entirety for all purposes.

### BACKGROUND

The present invention relates generally to a process and system for managing worker efficiency issues in a job scheduling system, and in one particular example for processing data such as genomic sequence data.

### SUMMARY

According to one aspect of the present invention, a computer implemented method for managing job scheduling is provided. In one example, the method includes receiving a request to process a job for a first compute instance, the job having a predetermined wait time before requesting a second compute instance, and determining the status of a pool of existing instances potentially available to service the job. If the probability that a computing instance of the pool will become available before the predetermined wait time is less than a predetermined probability, the method schedules the job to a new instance of the pool of existing instances. If the probability that a computing instance will become available before the predetermined wait time is greater than the predetermined probability the method maintains the job with the first instance. In some examples, the compute instances relate to genomic sequence data processing and analysis.

According to other aspects of the invention, non-transitory computer readable medium and systems for managing job scheduling and worker reuse are provided.

### BRIEF DESCRIPTION OF THE DRAWINGS

FIG. 1 illustrates an exemplary process for managing worker efficiency in a job scheduling system.

FIG. 2 illustrates an exemplary system for carrying out aspects of a job scheduling system.

FIG. 3 illustrates an exemplary environment in which certain steps, operations, and methods described herein are carried out.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

Worker reuse deadline, “WRD” for the remainder of this document, is a solution to manage the “worker efficiency” problem in a job scheduling system. In most cloud environments, compute instances are billed by the hour, rounded up. For any given compute instance, the worker efficiency of that instance is a fraction between 0 and 1 which represents the portion of the billable hours that were used to execute jobs. If a worker is provisioned, and runs a job for 6 minutes, and is then terminated, this would be a worker efficiency of 10% (6/60).

WRD is a parameter which can be used to manage the average worker efficiency of a system. The most basic version of this is to define an integer, which is the number of seconds that a job is willing to wait before requesting a new compute instance to be provisioned. If this value is set to 600, a job will wait up to 10 minutes to utilize a compute instance that became available in the time after the job was submitted, but before 10 minutes later. Generally, setting the value high allows a longer time to find a worker to reuse, however, may delay results, and setting the value low, maybe expedite results, but result in very little reuse.

WRD is a straightforward concept, but it lends itself to a few enhancements which will greatly reduce the false positive case, which is the case in which the job waits its entire WRD but ends up provisioning a new compute instance anyway. In this case, it would be much preferred to avoid the waiting in the first place. The first enhancement requires visibility into the existing pool of compute instances. Visibility may be achieved by updating the system to track the instances. For example, a process may update the system to keep a list of the workers in the primary database, so anyone can query them.

If there is no instance currently running which satisfies the requirements of the job, then no amount of waiting will allow for an instance to be reused. If an instance is running which satisfies the constraints, the system/process will wait up until the maximum wait time to allow the current job to finish, such that it would be able to reuse the worker.

The second enhancement is about estimating the probability that one of the qualifying workers will become available before the WRD duration expires. This requires capturing runtime statistics, which would enable an estimation of the probability that the job will reuse a worker. In other words, by capturing runtime statistics, the system or process will be able to estimate the probability of fulfillment prior to waiting, so the system/process can make an informed decision about whether or not to wait based on the probability of fulfillment. This additional parameter is referred to herein as RP (Reuse Probability). With WRD and RP known the system can increase the WRD while managing the false positive rate with RP. For example, consider a configuration which has WRD=30 m RP=0.9. This would avoid waiting up to 30 minutes unless the chance of reusing the worker was greater than or equal to 90%.

Accordingly, such a process and system allows an increase in the WRD, and so long as the RP is below a threshold, the job will likely switch off to another instance and not have to wait the full period. This requires visibility into other instances that can service the job, and also are capable of servicing the job.

Another enhancement for WRD includes workflow level optimization. While one may find some reasonable WRD and RP parameters for an individual job, users may often want to limit the maximum delay across a hierarchical pipeline of jobs. Accordingly, in one example, a third parameter can be introduced into the process/system, which is the Pipeline Reuse Tolerance “PRT”. This is the total amount of time that jobs in a hierarchical pipeline can spend waiting to reuse a worker. This is implemented for all paths down the job tree. Specifically if WRD=30 m, RP=0.9, and PRT=45 m, sibling jobs can each wait 30 minutes, but if a parent job has already waited 20 minutes, then any of its descendants only have 25 minutes of wait time still available. When PRT is not much larger than WRD, it's important to have RP sufficiently high to avoid a single job in the tree, particularly the root execution, from exhausting the wait time for a false positive reuse opportunity.

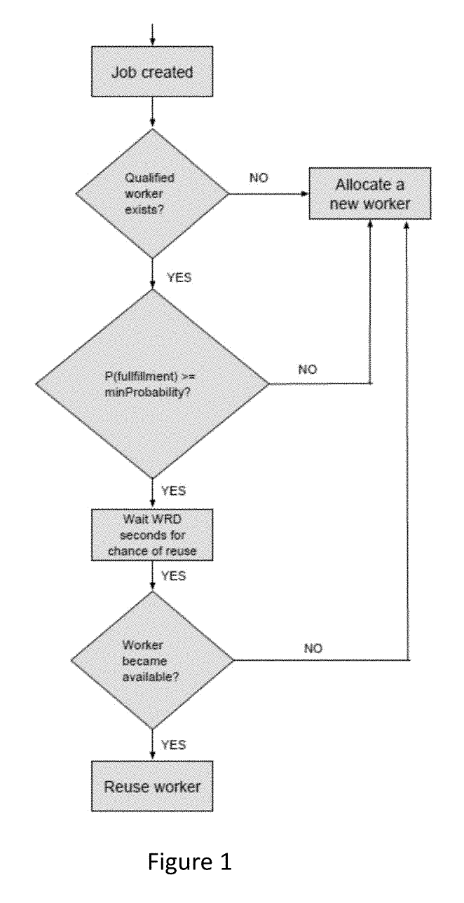

FIG. 1 illustrates a basic process based on the above exemplary description. In particular, as a job is created, the process can first determine if a qualified worker exists. If not, a new worker can be allocated. If a qualified worker does exist, the system can further determine if the probability of fulfillment of the job is greater than a threshold probability. If no, a new worker is allocated. If yes, however, the job may wait WRD for the chance to reuse a worker, if a worker becomes available in the WRD time period (if a worker does not become available to reuse than a new worker is used).

It should be noted that the exemplary process and system described herein may be carried out by one or more server systems, client devices, and combinations thereof. Further, server systems and client systems may include any one of various types of computer devices, having, e.g., a processing unit, a memory (which may include logic or software for carrying out some or all of the functions described herein), and a communication interface, as well as other conventional computer components (e.g., input device, such as a keyboard/touch screen, and output device, such as display). Further, one or both of server system and clients generally includes logic (e.g., http web server logic) or is programmed to format data, accessed from local or remote databases or other sources of data and content. To this end, a server system may utilize various web data interface techniques such as Common Gateway Interface (CGI) protocol and associated applications (or “scripts”), Java® “servlets,” i.e., Java® applications running on a server system, or the like to present information and receive input from clients. Further, server systems and client devices generally include such art recognized components as are ordinarily found in computer systems, including but not limited to processors, RAM, ROM, clocks, hardware drivers, associated storage, and the like. Further, the described functions and logic may be included in software, hardware, firmware, or combinations thereof.

Additionally, a non-transitory computer-readable medium can be used to store (e.g., tangibly embody) one or more computer instructions/programs for performing any one of the above-described processes by means of a processor. The computer program may be written, for example, in a general-purpose programming language (e.g., Pascal, C, C++, Java) or some specialized application-specific language.

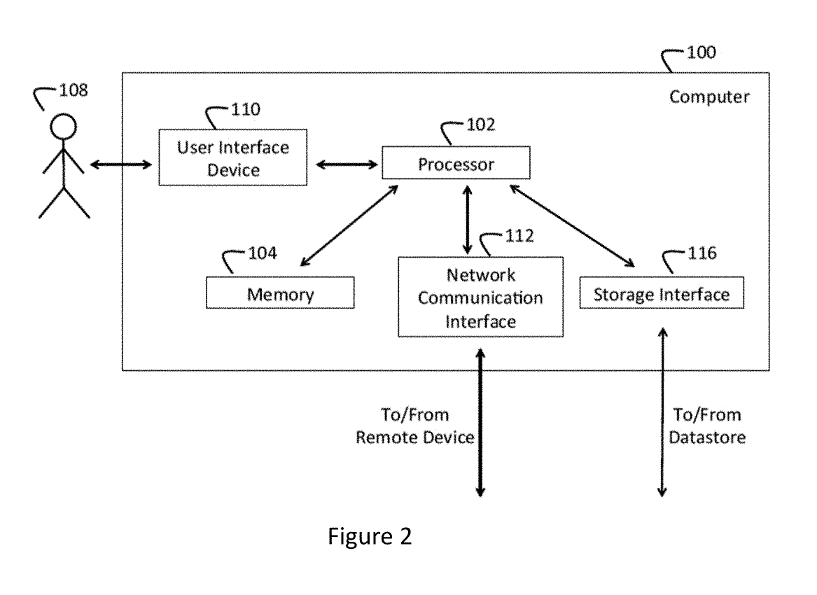

FIG. 2 is a block diagram of an exemplary computer or computing system 100 that may be used to construct a system for executing one or more processes described herein. Computer 100 includes a processor 102 for executing instructions. The processor 102 represents one processor or a multiprocessor system including several processors (e.g., two, four, eight, or another suitable number). Processor 102 may include any suitable processor capable of executing instructions. For example, in various embodiments processor 102 may be general-purpose or embedded processors implementing any of a variety of instruction set architectures (ISAs), such as the x86, PowerPC, SPARC, or MIPS ISAs, or any other suitable ISA. In multiprocessor systems, each of processors may commonly, but not necessarily, implement the same ISA. In some embodiments, executable instructions are stored in a memory 104, which is accessible by and coupled to the processor 102. Memory 104 is any device allowing information, such as executable instructions and/or other data, to be stored and retrieved. A memory may be volatile memory, nonvolatile memory or a combination of one or more volatile and one or more nonvolatile memory. Thus, the memory 104 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Computer 100 may, in some embodiments, include a user interface device 110 for receiving data from or presenting data to user 108. User 108 may interact indirectly with computer 100 via another computer. User interface device 110 may include, for example, a keyboard, a pointing device, a mouse, a stylus, a touch sensitive panel (e.g., a touch pad or a touch screen), a gyroscope, an accelerometer, a position detector, an audio input device or any combination thereof. In some embodiments, user interface device 110 receives data from user 108, while another device (e.g., a presentation device) presents data to user 108. In other embodiments, user interface device 110 has a single component, such as a touch screen, that both outputs data to and receives data from user 108. In such embodiments, user interface device 110 operates as a component or presentation device for presenting or conveying information to user 108. For example, user interface device 110 may include, without limitation, a display device (e.g., a liquid crystal display (LCD), organic light emitting diode (OLED) display, or electronic ink display), an audio output device (e.g., a speaker or headphones) or both. In some embodiments, user interface device 110 includes an output adapter, such as a video adapter, an audio adapter or both. An output adapter is operatively coupled to processor 102 and configured to be operatively coupled to an output device, such as a display device or an audio output device.

Computer 100 includes a storage interface 116 that enables computer 100 to communicate with one or more of data stores, which store virtual disk images, software applications, or any other data suitable for use with the systems and processes described herein. In exemplary embodiments, storage interface 116 couples computer 100 to a storage area network (SAN) (e.g., a Fibre Channel network), a network-attached storage (NAS) system (e.g., via a packet network) or both. The storage interface 116 may be integrated with network communication interface 112.

Computer 100 also includes a network communication interface 112, which enables computer 100 to communicate with a remote device (e.g., another computer) via a communication medium, such as a wired or wireless packet network. For example, computer 100 may transmit or receive data via network communication interface 112. User interface device 110 or network communication interface 112 may be referred to collectively as an input interface and may be configured to receive information from user 108. Any server, compute node, controller or object store (or storage, used interchangeably) described herein may be implemented as one or more computers (whether local or remote). Object stores include memory for storing and accessing data. One or more computers or computing systems 100 can be used to execute program instructions to perform any of the methods and operations described herein. Thus, in some embodiments, a system comprises a memory and a processor coupled to the memory, wherein the memory comprises program instructions executable by the processor to perform any of the methods and operations described herein.

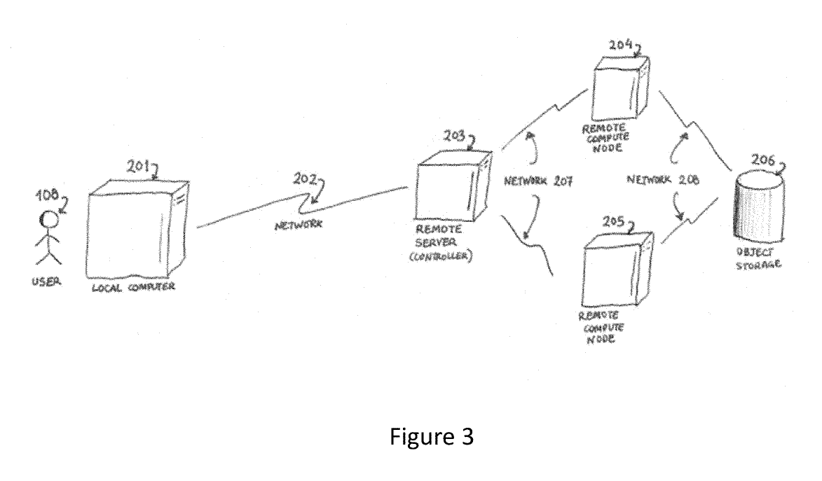

FIG. 3 shows a diagram of an exemplary system for performing the steps, operations, and methods described herein, particularly within a cloud environment. From the point of view of user 108, the user interacts with one or more local computers 201 in communication with one or more remote servers (controllers) 203 by way of one or more networks 202. User 108, via his or her local computers 201, instructs controllers 203 to initiate processing. The remote controllers 203 may themselves be in communication with each other through one or more networks 202 and may be further connected to one or more remote compute nodes 204/205, also via one or more networks 207. Controllers 203 provision one or more compute nodes 204/205 to process the data, such as genomic sequence data. Remote compute nodes 204/205 may be connected to one or more object storage 206 via one or more networks 208. The data, such as genomic sequence data, may be stored in object storage 206. In some embodiments, one or more networks shown in FIG. 3 overlap. In some embodiments, the user interacts with one or more local computers in communication with one or more remote computers by way of one or more networks. The remote computers may themselves be in communication with each other through the one or more networks. In some embodiments, a subset of local computers is organized as a cluster or a cloud as understood in the art. In some embodiments, some or all of the remote computers are organized as a cluster or a cloud. In some embodiments, a user interacts with a local computer in communication with a cluster or a cloud via one or more networks. In some embodiments, a user interacts with a local computer in communication with a remote computer via one or more networks. In some embodiments, a file, such as a genomic sequence file or an index, is stored in an object store, for example, in a local or remote computer (such as a cloud).

1. A computer implemented method for managing job scheduling, comprising:
receiving a request to process a job for a first compute instance, the job having a predetermined wait time before requesting a second compute instance;
determining the status of a pool of existing instances potentially available to service the job, and:
if the probability that a computing instance of the pool will become available before the predetermined wait time is less than a predetermined probability, scheduling the job to a new instance of the pool of existing instances; and
if the probability that a computing instance will become available before the predetermined wait time is greater than the predetermined probability maintaining the job with the first instance.

2. The method of claim 2, wherein the computing instance relates to genomic sequence data.

3. A non-transitory computer-readable storage medium comprising computer-executable instructions for:
receiving a request to process a job for a first compute instance, the job having a predetermined wait time before requesting a second compute instance;
determining the status of a pool of existing instances potentially available to service the job, and:
if the probability that a computing instance of the pool will become available before the predetermined wait time is less than a predetermined probability, scheduling the job to a new instance of the pool of existing instances; and
if the probability that a computing instance will become available before the predetermined wait time is greater than the predetermined probability maintaining the job with the first instance.

4. A system comprising:
one or more processors;
memory; and
one or more programs, wherein the one or more programs are stored in the memory and configured to be executed by the one or more processors, the one or more programs including instructions for:
receiving a request to process a job for a first compute instance, the job having a predetermined wait time before requesting a second compute instance;
determining the status of a pool of existing instances potentially available to service the job, and:
if the probability that a computing instance of the pool will become available before the predetermined wait time is less than a predetermined probability, scheduling the job to a new instance of the pool of existing instances; and
if the probability that a computing instance will become available before the predetermined wait time is greater than the predetermined probability maintaining the job with the first instance.
